(19) United States
(12) Patent Application Publication
(10) Pub. No.: US 2019/0357670 A1
(43) Pub. Date: Nov. 28, 2019

(54) LegDesk

(71) Applicant: Eric Olsen, Santaquin, UT (US)

(72) Inventor: Eric Olsen, Santaquin, UT (US)

(21) Appl. No.: 15/820,387

(22) Filed: Nov. 21, 2017

(51) Int. Cl. A47B 23/00; G06F 1/16; H04B 1/3877; H04B 1/3827

(52) U.S. Cl. CPC A47B 23/002; H04B 1/385; H04B 1/3877; G06F 1/163

(57) ABSTRACT

The LegDesk is a wedge shaped object made out of ABS plastic. The LegDesk is approximately 8⅛ inches long, 3 inches high at the highest part of the LegDesk, and approximately 4⅛ inches wide. The wedge shape has a sloping angle of about 20 degrees. Each side of the LegDesk contains 2 skinny rectangular holes to house nylon straps. The LegDesk is completely open when turned upside down, having no bottom enclosure.

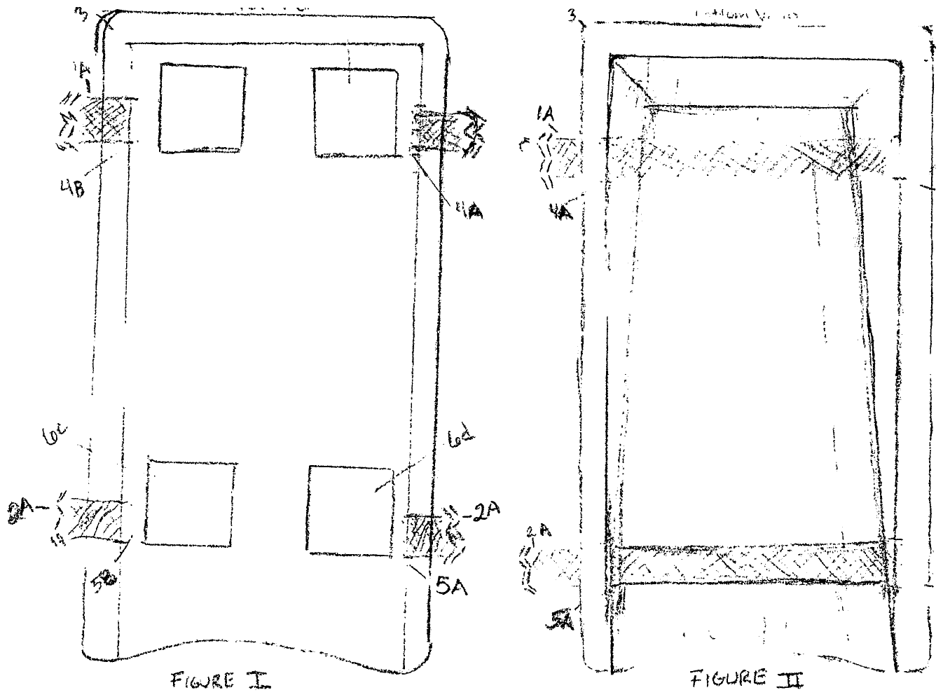

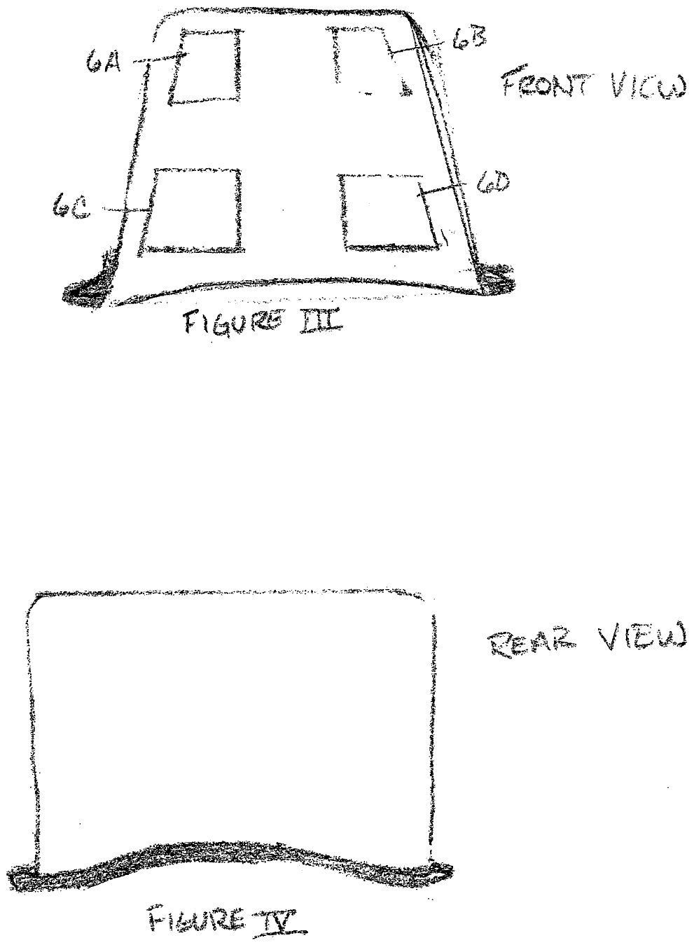

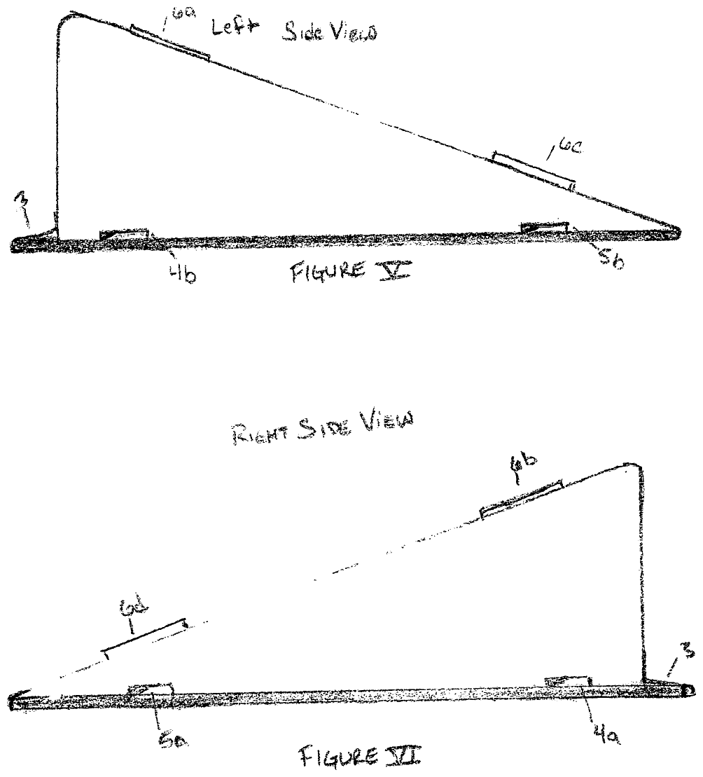

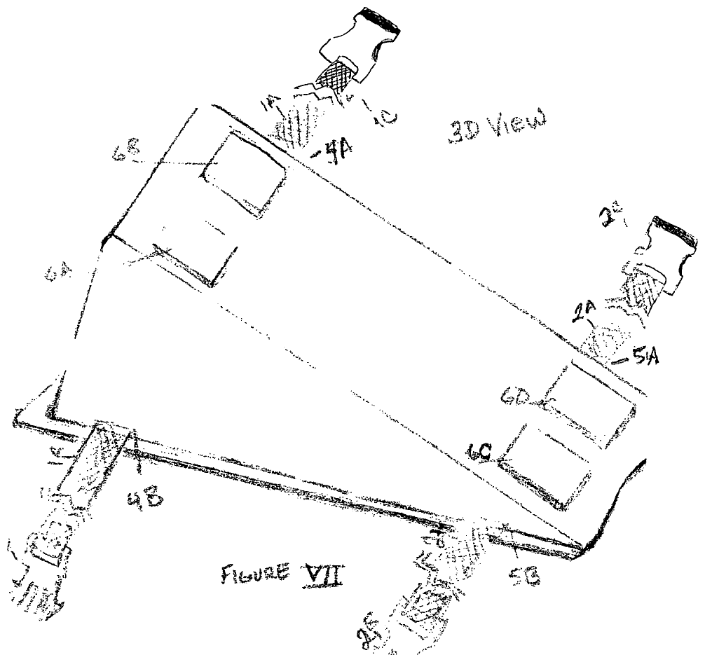

The LegDesk has an angle to provide optimum viewing while seated. The LegDesk is attached to the user's leg with 2 nylon straps (Parts 1A and 2A). Each strap has a parachute buckle clip (Parts 1B and 2B) and a parachute buckle receiver for the clip (Parts 1C and 2C). The LegDesk is surrounded by a plastic rim (Part 3) and has 4 small rectangular openings (Parts 4A, 4B, 5A, and 5B) to contain the straps. The user's device will attach to the LegDesk by adhering to adhesive gel pads (Parts 6A, 6B, 6C, and 6D).

### BACKGROUND

The LegDesk pertains to accessories for hand-held electronics (e.g. tablets, smartphones, e-book readers, or GPS navigators). More specifically, the LegDesk pertains to securely mounting hand-held electronic devices. While other inventions have sought to secure such devices for hands-free operation, the LegDesk uses a unique approach that can attach almost any hand-held device to the user's leg.

### BRIEF SUMMARY

The LegDesk secures an electronic device (e.g. tablet, smartphone, e-book reader, or GPS navigator) to a user's leg while in a seated position. The LegDesk is wedge shaped and has an angle to provide optimum viewing while seated. It's made out of plastic. Almost any tablet, smartphone, e-book, or GPS navigator can be secured to the LegDesk when adhering to adhesive gel pads.

### DESCRIPTION OF THE SEVERAL VIEWS OF THE DRAWINGS

FIG. I depicts a top view of the LegDesk, as if a user strapped the LegDesk to a leg and is looking down directly over the LegDesk.

FIG. II depicts a bottom view of the LegDesk to show the hollow underside of the LegDesk when turned upside down (the inverse of the top view).

FIG. II depicts a front of view of the LegDesk to display slope of the LegDesk.

FIG. IV depicts the rear view, as if the user rotated the LegDesk 180 degrees from the top view in order to view the back of the LegDesk.

FIG. V depicts the left side view when strapped to the user's leg.

FIG. VI depicts the right side view when strapped to the user's leg.

FIG. VII depicts a 3D view by displaying the top and left side of the LegDesk.

### DETAILED DESCRIPTION

The LegDesk is attached to the user's leg with 2 nylon straps (Parts 1A and 2A). Each strap has a parachute buckle clip (Parts 1B and 2B) and a parachute buckle receiver for the clip (Parts 1C and 2C). The LegDesk is surrounded by a plastic rim (Part 3) and has 4 small rectangular openings (Parts 4A, 4B, 5A, and 5B) to contain the straps. The user's device will attach to the LegDesk by adhering to adhesive gel pads (Parts 6A, 6B, 6C, and 6D).

### FIGURES

FIG. I—Top View
FIG. II—Bottom View
FIG. III—Front View
FIG. IV—Rear View
FIG. V—Left Side View
FIG. VI—Right Side View
FIG. VII—3D View

### PARTS

1A—1 cm woven nylon strap
1B—Parachute buckle clip
1C—Parachute buckle receiver
2A—1 cm woven nylon strap
2B—Parachute buckle clip
2C—Parachute buckle receiver
3—1 cm wide plastic rim
4A—1 cm×0.5 cm opening
4B—1 cm×0.5 cm opening
5A—1 cm×0.5 cm opening
5B—1 cm×0.5 cm opening
6A—1″ Adhesive gel pad
6B—1″ Adhesive gel pad
6C—1″ Adhesive gel pad
6D—1″ Adhesive gel pad

1. A tablet or smartphone mounting device comprising:
(a) a plastic wedge that is strapped to the user's leg and
(b) means for the said wedge to secure a tablet, smartphone, or other electronic device at an optimum viewing angle for the user,
whereby said wedge can be strapped to the user's leg while a tablet (or any similar electronic device) is secured to the wedge, for the purpose of securing and operating a tablet (or similar device) while seated.
